(19) United States
(12) Patent Application Publication
(10) Pub. No.: US 2023/0415834 A1
(43) Pub. Date: Dec. 28, 2023

(54) METHOD FOR APPLYING TENSION TO AERODYNAMIC TRAILER SKIRT

(71) Applicants: Calvin Rhett BRADLEY, Greenville, SC (US); COMPAGNIE GENERALE DES ETABLISSEMENTS MICHELIN, Clermont-Ferrand (FR)

(72) Inventor: Calvin Rhett BRADLEY, Blountville, TN (US)

(21) Appl. No.: 18/252,936

(22) PCT Filed: Dec. 8, 2020
(86) PCT No.: PCT/US2020/063711

§ 371 Date: May 15, 2023

(51) Int. Cl. B62D 65/16; B62D 35/00

(52) U.S. Cl. CPC B62D 65/16; B62D 35/001

(57) ABSTRACT

A method of attaching a trailer skirt (14) to a trailer (16) is provided in which the trailer skirt (14) has upper (38) and lower (40) surfaces spaced from one another in a vertical direction. The trailer skirt (14) has first (42) and second (44) attachment locations in which the first attachment location (42) is located forward of the second attachment location (44) in the longitudinal direction and closer to the leading terminal end in the longitudinal direction. The trailer skirt (14) has a third attachment location (46) that is located rearward of the second attachment location (44) in the longitudinal direction and closer to the trailing terminal end in the longitudinal direction. The method includes providing a trailer (16) of a tractor trailer and attaching the trailer skirt (14) to the trailer (16) at the first, second, and third attachment locations (42, 44, 46) such that the lower surface (40) is placed into tension.

### FIELD OF THE INVENTION

The subject matter of the present invention relates to a method of applying tension to a trailer skirt used to increase the aerodynamic performance of the tractor trailer. More particularly, the present application involves attaching the trailer skirt to the trailer so that tension is imparted at the bottom of the trailer skirt in order to preload the trailer skirt to both reduce or eliminate deformation and fluttering of the trailer skirt.

### BACKGROUND OF THE INVENTION

Trailers towed by trucks and similar apparatuses for transporting cargo can be large, unwieldy, and include geometries which invite inefficiencies during travel. One aspect of these inefficiencies concerns the aerodynamics of the trailer. For maximum capacity, the trailer is box shaped which is not the most aerodynamically available option. In an effort to improve trailer aerodynamics, trailers have been built, supplemented, or retro-fitted with trailer skirts (or side skirts), devices affixed to the underside which limit air circulating in the empty space between the trailer's axles. By reducing the amount of airflow in this space, drag caused by turbulence is reduced and permits the trailer to be towed more efficiently, increasing the gas mileage and performance of the vehicle and its cargo. Trailer skirts are flat panels that are attached to the bottom of the trailer at its sides under the trailer and extend in the longitudinal direction to deflect airflow in a desired manner.

The bottoms of trailers do not have a consistent vertical height from the ground upon extension in the longitudinal direction. Instead, the bottoms of trailers present a concave shape to the ground, and the trailer skirts with straight top edges are attached to this concave shaped bottom. Because of this arrangement, the bottom of the trailer skirt is put into compression which causes the lower edge of the trailer skirt to assume a wavy shape which can lead to vibration during operation and could prevent optimal aerodynamic performance. In addition to this deformation issue, the hanging of a trailer skirt off of the bottom of the trailer may result in a trailer skirt that is not preloaded and could vibrate due to unsteady forces from air impacting the trailer skirt, which is known as flutter.

Two different approaches are known to correct these problems. The first involves positioning the front of the trailer skirt inboard from the main, tailing section of the trailer skirt. This out of plane curvature increases stiffness of the skirt panel to reduce vibration and deformation. However, the inclusion of a curved leading section of the trailer skirt may not be desired for many optimized aerodynamic configurations which reduces the performance of the system. The second correction involves adding additional bracket support by increasing the number of brackets or increasing bracket stiffness to hold the trailer skirt in a straighter position with less flexibility. Unfortunately, the addition of stronger or additional brackets adds cost and weight to the design and is not always successful. Further, since the trailer skirt is not under pretension, it may still flutter when subjected to air forces when moving down the road and vibrate which can result in reduced aerodynamic performance. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a side view of a tractor trailer with an unattached trailer skirt of the prior art.

FIG. 2 is a side view of FIG. 1 with the trailer skirt attached to the trailer.

FIG. 3 is a side view of a tractor trailer with an unattached trailer skirt in accordance with one exemplary embodiment.

FIG. 4 is a side view of FIG. 3 with the trailer skirt attached to the trailer.

FIG. 5 is a back side view of a trailer skirt in accordance with another exemplary embodiment of the method.

FIG. 6 is a side view of the trailer skirt attached to the trailer in accordance with another exemplary embodiment of the method in which the upper surface does not exactly match the bottom surface of the trailer.

FIG. 7 is a side view of a trailer skirt that has an upper surface that is convex along its entire length.

FIG. 8 is a top view of the trailer skirt of FIG. 7.

FIG. 9 is a side view of a trailer skirt that has an upper surface with convex segments, inclined segment, and flat segments in accordance with another embodiment.

FIG. 10 is a side view of the trailer skirt of FIG. 9 attached to the trailer.

FIG. 11 front view of the trailer skirt of FIG. 10.

FIG. 12 is a front view of the trailer skirt of FIG. 11 with bending members and skirt attachments added to the apparatus to straighten the trailer skirt.

FIG. 13 is a side view of the trailer skirt in accordance with another embodiment of the method in which the bottom of the trailer is composed of a series of I-beams.

FIG. 14 is a side view of the trailer skirt and trailer in accordance with another embodiment of the method in which the trailer skirt has a flat upper surface, and in which the bottom surface of the trailer is also flat.

FIG. 15 is a side view of FIG. 14 showing a subsequent step in which a bracket of the trailer skirt is attached to a spacer of the trailer.

FIG. 16 is a side view of FIG. 15 showing a subsequent step in which additional brackets of the trailer skirt are attached to the trailer.

FIG. 17 is a side view of a trailer and trailer skirt in accordance with another exemplary embodiment of the method in which the bottom of the trailer skirt has a concave shape and in which the trailer skirt has a flat upper surface.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a method of attaching a trailer skirt 14 to a trailer 16 in which a lower surface 40 of the trailer skirt 14 is put into tension. The tension may establish a preload of the trailer skirt 14 so that it does not flutter when the tractor trailer 12 travels down the road, and so that the trailer skirt 14 is not wavy and will achieve better aerodynamic performance in use. The trailer skirt 14 has first, second and third attachment locations 42, 44, 46 that are positioned and/or attached to the trailer 16 in a manner that imparts the tension onto the trailer skirt 14. The upper surface 38 of the trailer skirt 14 may be straight, convex, or variously shaped in accordance with different embodiments, and the bottom 50 of the could be straight, concave, or variously shaped in different embodiments of the method.

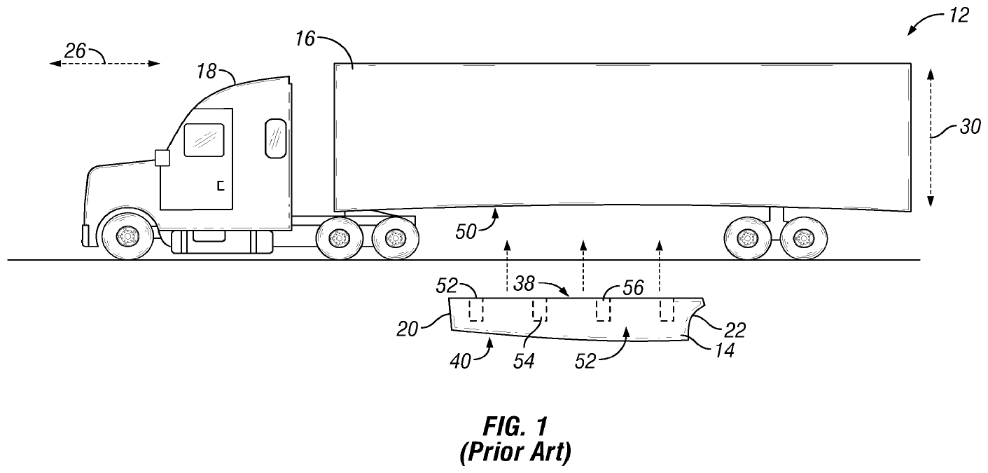

FIG. 1 shows a tractor trailer 12 that has a tractor 18 and attached trailer 16.

In normal use, the tractor trailer 12 is driven forward in the longitudinal direction 26 and cargo for transport is held in the trailer 16. The trailer 16 is elongated in the longitudinal direction 26 and has a bottom surface 50 that is convex such that the bottom surface 50 is not the same distance in the vertical direction 30 from the ground along the entire length of the bottom surface 50 in the longitudinal direction 26. The trailer skirt 14 has an upper surface 38 that is flat in that the height of the upper surface 38 in the vertical direction 30 does not change along the entire longitudinal length of the upper surface 38 in the longitudinal direction 26. The trailer skirt 14 is an aerodynamic feature placed onto the tractor trailer 12 to improve aerodynamic performance of the tractor trailer 12 during forward movement. In this regard, the trailer skirt 14 deflects air in a desired manner to reduce drag, such as for instance deflecting air away from the trailer tires and suspension so that this air does not engage and slow the tractor trailer 12 down during forward movement.

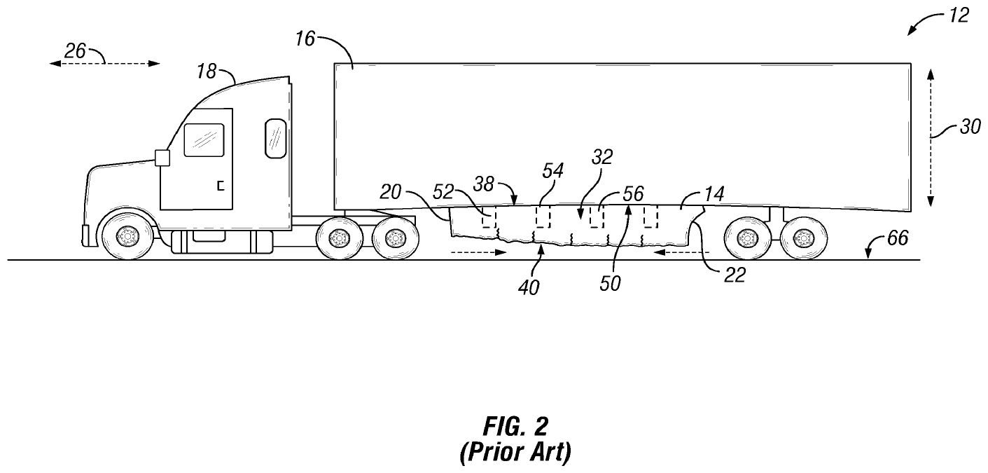

The trailer skirt 14 is installed on the trailer 16 and is usually placed in the longitudinal direction 26 between the tractor 18 tires and the trailer 16 tires. One trailer skirt 14 is attached to the left hand side of the tractor 18, and another trailer skirt 14 is attached to the right hand side of the tractor 16. FIG. 2 shows the attachment of the trailer skirt 14 to the trailer 16 so that the upper surface 38 engages the bottom surface 50. Due to the fact that the bottom surface 50 is concave in shape while the upper surface 38 is flat, these two components do not fit nicely onto one another. Instead, their mismatched shapes cause the trailer skirt 14 to be forced against bottom surface 50 so that the center in the longitudinal direction 26 of the trailer skirt 14 is placed into compression. This compression will be most felt at the lower surface 40 of the trailer skirt 14 to result in a series of wrinkles to be formed in the trailer skirt 14 to results in a wavy trailer skirt 14 along its lower surface 40. This deformation will change or reduce the effectiveness of the aerodynamic design of the trailer skirt 14 and will allow the trailer skirt 14 to flutter during forward movement of the tractor trailer 12.

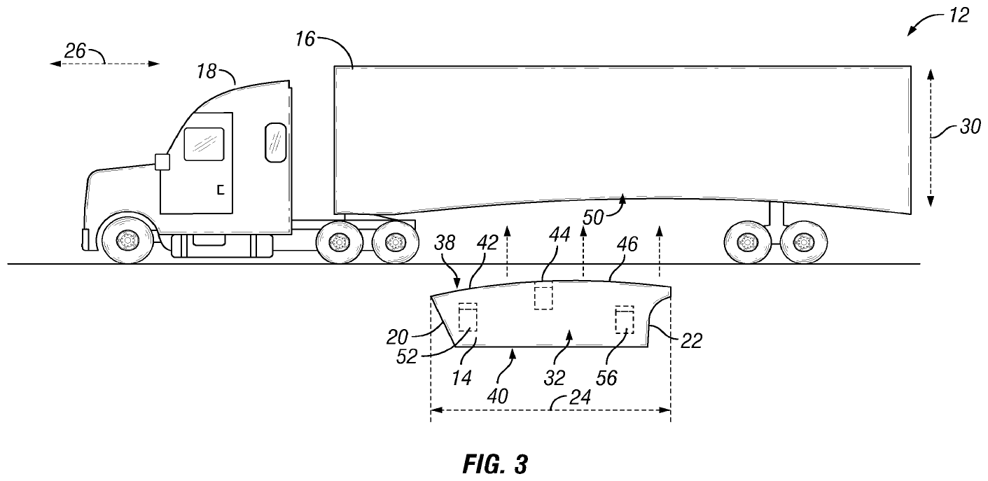

FIG. 3 shows an apparatus in accordance with one exemplary embodiment. The apparatus includes a trailer skirt 14 that can be a single panel or can be made of multiple panels. The panels of the trailer skirt 14 may be made out of fiberglass and extend a longer length in the longitudinal direction 26 than in the vertical direction 30 or lateral direction 28. The placement of the trailer skirt 14 is again between the tires of the tractor 18 and trailer 16 in the longitudinal direction 26, but in other embodiments the trailer skirt 14 could extend to the tires of the trailer 16 and may extend rearward of the tires of the trailer 16 in the longitudinal direction 26. Still further, the trailer skirt 14 could extend forward in the longitudinal direction 26 so as to be at or forward of the drive tires of the tractor 18. A length 24 in the longitudinal direction 26 extends from the leading terminal end 20 to the trailing terminal end 22 of the trailer skirt 14. Due to the geometries of the leading and trailing terminal ends 20, 22, the length 24 can be varied based upon the height in the vertical direction 30 the length 24 is measured. As such, the length 24 can be the maximum measured length of the trailer skirt 14 in the longitudinal direction 26.

The trailer skirt 14 has an upper surface 38 and an oppositely disposed lower surface 40 that are spaced from one another a distance in the vertical direction 30. The upper surface 38 has a first attachment location 42 and a second attachment location 44, and the first attachment location 42 is located forward of the second attachment location 44 in the longitudinal direction 26 so as to be located closer to the leading terminal end 20 in the longitudinal direction 26. The second attachment location 44 is located closer to the trailing terminal end 22 in the longitudinal direction 26 than the first attachment location 42. The first and second portions 42, 44 can extend any length in the longitudinal direction 26 and need not be a point or line but could be a surface with the same or different lengths as one another. The second attachment location 44 is higher in the vertical direction 30 than the first attachment location 42. As can be appreciated, if the bottom surface 50 of the trailer 16 is concave in shape, the higher second attachment location 44 and lower first attachment location 42 will better fit with this concave shape bottom surface 50. The upper surface 38 in this embodiment is complimentary in shape with the bottom surface 50 so that their convex and concave shapes match and fit with one another.

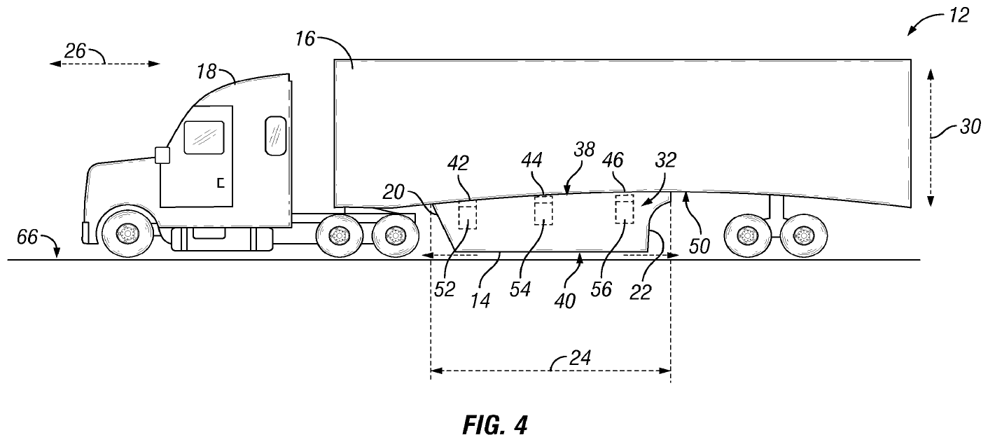

FIG. 4 shows the trailer skirt 14 attached to the trailer 16 so that the upper surface 38 engages the bottom surface 50. As these two surfaces 38, 50 are shaped to fit one another, portions of the trailer skirt 14 are not pulled out of position and forced against the trailer 16 upon attaching the trailer skirt 14. Compression or other forces will not be imparted onto the lower surface 40 or other section of the trailer skirt 14 so that wrinkles or waves will not be formed on the trailer skirt 14. The outer surface 32 of the trailer skirt 14 is not deformed in the attachment process and will function to deflect air as intended upon design of the trailer skirt 14 in the apparatus for aerodynamic gains of the tractor trailer 12. During attachment of the trailer skirt 14, the second attachment location 44 is located higher in the vertical direction than the first attachment location 42. The bottom surface 50 of the trailer 16 onto which the trailer skirt 14 is affixed can be a single continuous surface that extends along the bottom of the trailer 16, or may be a series of I-beams that are spaced from one another in the longitudinal direction 26 along the bottom of the trailer 16, or may be a combination of these features at the bottom of the trailer 16. As such, it is to be understood that the bottom surface 50 can be a continuous surface or a discontinuous surface onto which the trailer skirt 14 is attached. The bottom surface 50 can extend any distance inboard from the side edge of the trailer 16 in the lateral direction 28. Various mechanisms of attaching the trailer skirt 14 to the trailer 16 are possible, and the upper surface 38 may or may not come into contact with the bottom surface in accordance with various exemplary embodiments. The vertical and longitudinal placements of the first and second attachment locations 42, 44 of the upper surface 38 will prevent interference that leads to compression and subsequent deformation of the trailer skirt 14. The first and second mounting brackets 52, 54 can be pulled into engagement with the bottom surface 50 and attached thereto to cause the attachment locations 42, 44 to engage and be attached to the bottom surface 50. The first mounting bracket 52 is shown as being displaced from the upper surface 38 in the vertical direction 30 and the first mounting bracket 52 can be pulled into engagement with the bottom surface 50 for attachment which will deform this portion of the trailer skirt 14 some amount to effect attachment. The second mounting bracket 54 will not need to be pulled into engagement to the bottom surface 50 so that portions of the trailer skirt 14 at the second mounting bracket 54 will not need to be deformed to effect engagement.

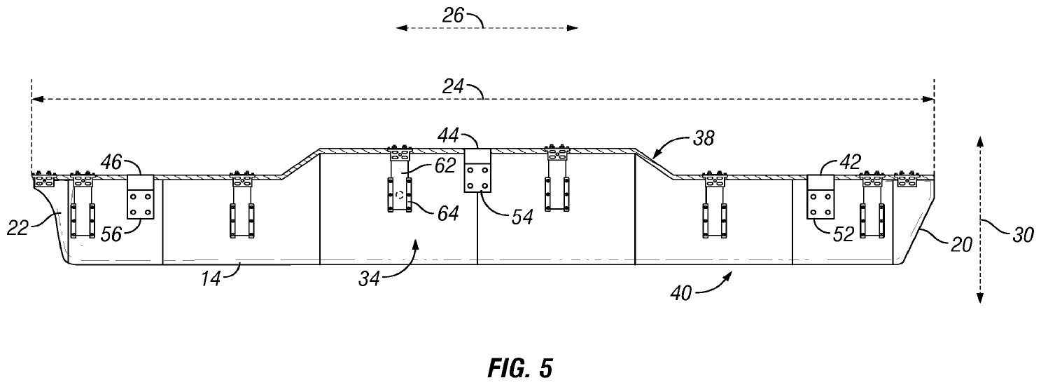

The upper surface 38 can be variously shaped and need not be convex in shape along its entire length from the leading terminal end 20 to the trailing terminal end 22. FIG. 5 is a back view of the trailer skirt 14 of the apparatus 10 in which upper surface 38 does not have any convex shape but instead only includes flat sections that are parallel to the longitudinal direction 26 and inclined sections that are angled to the longitudinal direction 26 so as to have components of extension in both the longitudinal direction 26 and the vertical direction 30. The first attachment location 42 of the upper surface 38 is closer to the leading terminal end 20 in the longitudinal direction 26, and the second attachment location 44 is again farther from the leading terminal end 20 and is higher in the vertical direction 30 than the first attachment location 42. A third attachment location 46 is also present and is part of the upper surface 38 and is located closer to the trailing terminal end 22 in the longitudinal direction than is the second attachment location 44 to the trailing terminal end 22. The third attachment location 46 is lower in the vertical direction 30 than the second attachment location 44. In the disclosed embodiment, the first and second portions 42 and 46 are located at the same height as one another in the vertical direction 30. The three attachment locations 42, 44 and 46 are located at the same height in the vertical direction 30 as the upper surface 38 and are three mounting brackets 52, 54, 56. The mounting brackets 52, 54, 56 need not be present in other embodiments. Here, the upper surface 38 could extend in the lateral direction 28 some amount to form flanges that are attached to the bottom surface 50. These flanges need not even be present in yet other arrangements in which the upper surface 38 itself is attached to the bottom surface 50. As such, the attachment locations 42, 44, 46 could be integrally formed with the upper surface 38, components different from the upper surface 38, or could be a combination of both the upper surface 38 and other components separate from the upper surface 38.

The attachment locations 42, 44, 46 are located along the flat sections of the upper surface 38 that are parallel to the longitudinal direction 26, and the second attachment location 44 is located at a section of the upper surface 38 that is elevated from the two sections onto which the first and third attachment locations 42, 46 are located. The second attachment location 44 in all of the various embodiments may be higher than the first and third attachment locations 42, 46 and the amount higher can be different in accordance with different embodiments. In various embodiments, the distance from the lower surface 40 to the second attachment location 44 in the vertical direction 30 is 2%, 3%, 4%, 5%, from 5%-10%, from 10%-15%, from 15%-20%, or up to 25% higher/longer than the distance from the lower surface to the first attachment location 42 in the vertical direction 30 and from the lower surface 40 to the third portion 42 in the vertical direction 30. In the instances where the lower surface 40 is not completely parallel to the longitudinal direction 26, the previously mentioned percentages will apply with the standard being the greatest height of the trailer skirt 14 from the lower surface 40 to the upper surface 38. In this regard, the heights of the attachment locations 42, 44, 46 will be measured relative to the lowest vertical position of the lower surface regardless of its position in the longitudinal direction 26 and once these three heights are measured the above mentioned percentages may be established. However, it is to be understood that regardless of the percentage difference, the second attachment location 44 need only be higher in the vertical direction 30 than the first and third portions 42, 46 in certain embodiments of the apparatus 10. The attachment location 42, 44, 46 measurement points can be at the engagement location of the attachment locations 42, 44, 46 to that of the bottom surface 50 since if the attachment locations 42, 44, 46 were brackets 52, 54, 56 they would have some position downward from the engagement points in the vertical direction 30.

The trailer skirt 14 includes bending members 62 and skirt attachments 64 located at different positions along the length 24. The bending members 62 and skirt attachments 64 can be configured in a variety of manners, for example they may be configured as those disclosed in United States patent publication number 2018/0290695 A1 the contents of which are incorporated by reference herein in their entirety for all purposes. The bending members 62 are mounted onto the bottom surface 50 of the trailer 16 or another part of the trailer 16 and include elongated bending beams that are in sliding engagement with skirt attachments 64. The skirt attachments 64 are rigidly mounted to the inner surface 34, and the elongated bending beams of the bending members 62 can slide through the skirt attachments 64. In FIG. 5, bending members 64 and skirt attachments 64 are located in the longitudinal direction 26 at different positions as the three attachment locations 42, 44, 46. Additional bending members 64 and skirt attachments 64 are located at additional positions along the longitudinal direction 26 as well.

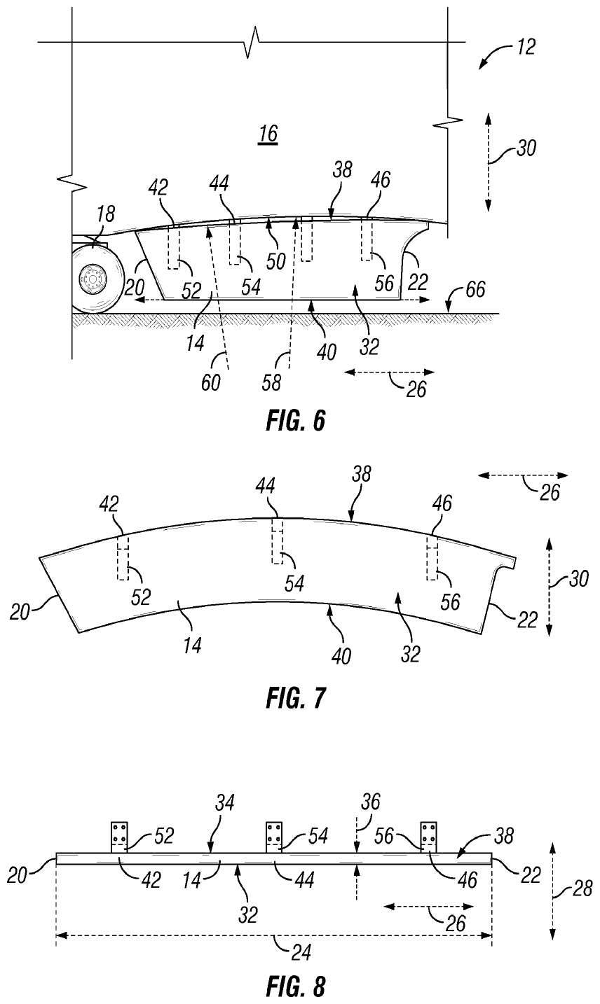

The upper surface 38 need not be completely complimentary with the bottom surface 50, and it may be the case that the upper surface 38 shown in FIG. 5 does not exactly match the shape of the bottom surface 50 of the trailer 16. However, if the shape of the upper surface 38 is closer to the shape of the bottom surface 50 than would otherwise be the case of the upper surface 38 is completely flat and parallel in the longitudinal direction 26, then this shape will still function to reduce compression on the trailer skirt 14 even through all of the compression of the trailer skirt 14 is not eliminated. FIG. 6 shows another embodiment of the apparatus in which the trailer skirt 14 is attached to the trailer 16. The trailer 16 has a bottom surface 50 that has a concave shape upon extension in the longitudinal direction 26. The bottom surface 50 has a radius of curvature 58 that establishes the concave shape of the bottom surface 50. The trailer skirt 14 has an upper surface 38 that is convex in shape but is not an exact match with the bottom surface 50 so that the upper surface 38 is not exactly complimentary in shape. The upper surface 38 has a radius of curvature 60 that establishes the convex shape of the upper surface 38 in the longitudinal direction 26. The radius of curvature 60 is not the same as the radius of curvature 58 so that the two surfaces 38, 50 are not complimentary in shape and do not fit exactly when the trailer skirt 14 is attached. The radius of curvature 60 is larger than the radius of curvature 58, but in other embodiments the radius of curvature 58 may be greater than the radius of curvature 60.

Even though the radii of curvatures 58, 60 are not identical, the convex shape of the upper surface 38 will still function to reduce some of the compression imparted onto the trailer skirt 14 when attached to the trailer 16. The convex shape of the upper surface 38 establishes a first attachment location 42 that is located lower in the vertical direction 30 than the subsequent second attachment location 44, and the second attachment location 44 is higher in the vertical direction 30 than the subsequent third attachment location 46. The upper surface 38 has a convex shaped segment and the three attachment locations 42, 44, 46 are all located along this convex shaped segment of the upper surface 38. The convex shaped segment may extend along the entire length of the upper surface 38 or may extend along less than the entire length of the upper surface 38 in the longitudinal direction 26. The convex shaped segment may be 10%, from 10%-25%, from 25%-45%, from 45%-50%, from 20%-50%, from 50%-75%, from 75%-90%, from 20%-90%, from 10%-100%, or from 20%-100% of the length of the upper surface 38 in the longitudinal direction 26. A first mounting bracket 52 is located at the same longitudinal position as the first attachment location 42, and a second mounting bracket 54 is located at the same longitudinal position as the second attachment location 44. A third mounting bracket 56 is positioned at the same longitudinal position as the third attachment location 46. The mounting brackets 52, 54, 56 can be rigidly attached to the trailer skirt 14 and to the bottom surface 50 or other portion of the trailer 16 to function to hold the trailer skirt 14 onto the trailer 16. Additional mounting brackets that are unlabeled in FIG. 6 can be located at different longitudinal positions along the trailer skirt 14 to provide further attachment support to the trailer skirt 14 and the trailer 16.

The tractor trailer 12 is shown engaging the ground 66 in FIG. 6. The first attachment location 42 is closer to the ground 66 in the vertical direction 30 than the second attachment location 44. Additionally, the third attachment location 46 is closer to the ground 66 in the vertical direction 30 than the second attachment location 44. The trailer skirt 14 is spaced from the ground 66 in the vertical direction 30 and the outer surface 32 faces outboard in the lateral direction 28 to deflect air in a desired manner upon driving the tractor trailer 12.

Another arrangement of the trailer skirt 14 of the apparatus 10 is shown in FIGS. 7 and 8. The upper surface 38 is convex along its entire length in the longitudinal direction 26, and the lower surface 40 has a concave surface along its entire length in the longitudinal direction 26. As such, the convex shaped segment of the upper surface 38 extends along the entire length of the upper surface 38 so all of it is convex. The second attachment location 44 is higher in the vertical direction 30 than the first attachment location 42 and the third attachment location 46. This highest point can be measured by measuring from the lowest point of the lower surface 40 vertically upward to the three attachment locations 42, 44, 46. This lowest point may not be under any of the three attachment locations 42, 44, 46 but may be offset from one, two or all of the three portions 42, 44, 46 in the longitudinal direction.

Mounting brackets 52, 54, 56 are all located at the three attachment locations 42, 44, 46. In this regard, the trailer skirt 14 has an outer surface 32 and an oppositely disposed inner surface 34 that are separated from one another in the lateral direction 28 and define between them a width 36 of the trailer skirt 14. The width 36 may be variable along the longitudinal direction 26 or can be the same along the entire length 24 of the trailer skirt 14. The mounting brackets 52, 54, 56 are not attached to the upper surface 38, but are instead attached to the inner surface 34. The height of the mounting brackets 52, 54, 56 may extend up to the heights of the attachment locations 42, 44, 46, or could be higher depending upon attachment availability of the trailer 16. The trailer skirt 14 extends straight in the longitudinal direction 26 and does not have a curved or inclined front section positioned inboard in the lateral direction 28 as do some trailer skirts 14 when installed on the trailer 16. This extension can be completely in the longitudinal direction 26 or may be inclined relative to the longitudinal direction 26 such that all portions of the trailer skirt 14 are angled the same relative to the longitudinal direction 26. However, the design of the apparatus 10 with the trailer skirt 14 allows for the trailer skirt 14 to have any portion positioned inboard in the lateral direction 28 than other portions of the trailer skirt 14 in accordance with various embodiments.

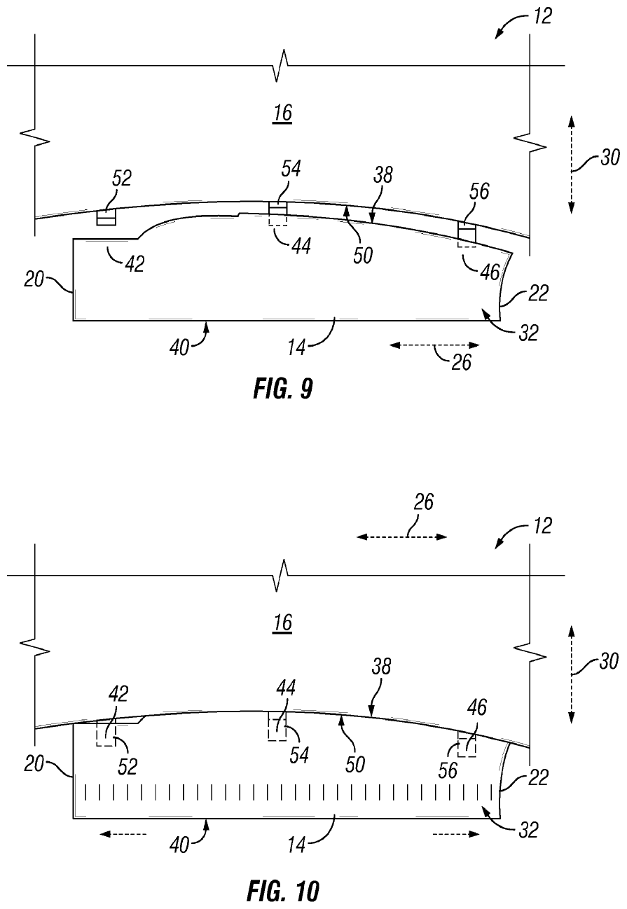

FIGS. 9 and 10 illustrate another embodiment of the trailer skirt 14 in which the upper surface 38 has a shape that varies at different points in the longitudinal direction 26. In FIG. 9, from the leading terminal end 20 the upper surface 38 is flat and is parallel to the longitudinal direction 26 and extends to a convex shaped segment. The first attachment location 42 is located in this initial section of the upper surface 38. The convex shaped segment of the upper surface 38 extends along approximately 10% of the length of the upper surface 38 to a flat section that extends slightly downward in the vertical direction 30 at an angle to the longitudinal direction 26. The upper surface 38 at this point steps upward to another flat section that is parallel to the longitudinal direction 26 and at which the second attachment location 44 is located. The upper surface 38 extends downward in the vertical direction 30 with another convex shaped portion that is almost flat all the way to the trailing terminal end 22, and the third attachment location 46 is located in this section of the upper surface 38. As such, the second attachment location 44 is higher than the first and third attachment locations 42, 46 in the vertical direction 30, but the upper surface 38 has a very complex shape along its length.

Mounting brackets 52, 54, 56 are attached to the trailer 16 and are positioned in the longitudinal direction 26 so that each one of them is at the same longitudinal position as each one of the first, second, and third attachment locations 42, 44, 46. The trailer skirt 14 is lifted into position and attached to the mounting brackets 52, 54, 56 as shown with reference to FIG. 10. Here, the mounting brackets 52, 54, 56 are attached to the inner surface 34 of the trailer skirt 14 and the second mounting bracket 54 can be attached first. The first and third mounting brackets 52, 56 due to the lower positioning of the first and third attachment locations 42 and 46 are farther from their necessary attachments to the first and third mounting brackets 52 and 56. The first and third attachment locations 42, 46 will be pulled upwards in the vertical direction 30 so that the inner surface 34 proximate to the first and third attachment locations 42, 46 can be attached to the first and third mounting brackets 52 and 56 to achieve attachment as shown in FIG. 10. As shown, a gap from the upper surface 38 to the bottom surface 50 is present along some of the first section of the upper surface and some of the convex shaped segment. The first attachment location 42 does not engage the bottom surface 50, but the second and third portions 44 and 46 do in fact engage bottom surface 50. The shape of the upper surface 38 does not exactly match the bottom surface 50 that it engages so some compression is still present in the trailer skirt 14. However, the pulling of the first and third portions 42, 46 a distance upwards in the vertical direction 30 will eliminate this compression and in fact cause tension to be put onto the lower surface 40 and the bottom section of the trailer skirt 14 as indicated by the arrows in FIG. 10.

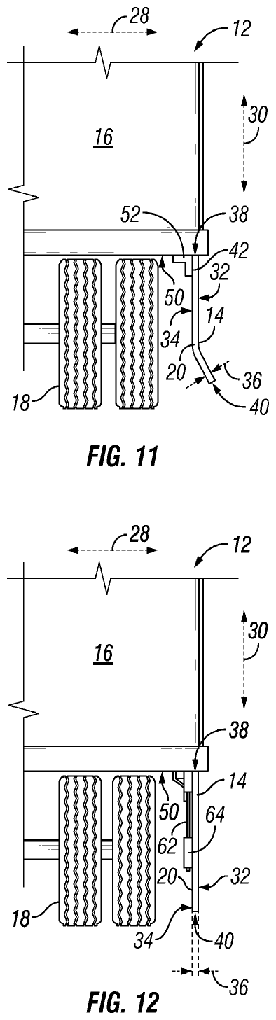

FIG. 11 is a front view of the trailer skirt 14 and trailer 16 of FIG. 10 in which the trailer skirt 14 is put into tension. When tension is applied to the trailer skirt 14 it will have to adjust for this by bending outward or inboard in the lateral direction 28, and the bottom section of the trailer skirt 14 is the part of the trailer skirt 14 that will become bent. In FIG. 11, the bottom of the trailer skirt 14 is bent outboard in the lateral direction 28 upon the application of tension onto the trailer skirt 14. The bottom surface 50 is shown as extending along the entire lateral width of the bottom of the trailer 16 in the lateral direction 28. The first mounting bracket 52 engages the bottom surface 50 and the inner surface 34 and holds the trailer skirt 14 onto the trailer 16, and the width 36 of the trailer skirt 14 can be seen as being constant along the entire height of the trailer skirt 14.

To correct the outboard bending of the trailer skirt 14 due to the application of tension, one or more bending member 62 and skirt attachment 64 assemblies can be incorporated into the apparatus 10. FIG. 12 shows the addition of one or more of these bending member/skirt attachment 62, 64 combinations to straighten out the trailer skirt 14. The bending member 62 is attached to the bottom surface 50 and has an elongated beam that slides through the skirt attachment 64 which is rigidly attached to the inner surface 34. The elongated beam of the bending member 62 functions to pull the trailer skirt 14 either inboard or outboard in the lateral direction 28 when the trailer skirt 14 is deflected upon hitting an obstacle when driving. Additionally, the bending member 62 functions to pull the deflected trailer skirt 14 back into a vertical orientation upon being deflected by the application of tension brought about by connection to the trailer bottom 50 as discussed. The bending member 62 thus acts to reshape the trailer skirt 14 in the lateral direction 28 so that it assumes a vertically oriented position as shown in FIG. 12. The trailer skirt 14 may still be in tension via the attachment, but the bending members 62 act to pull the trailer skirt 14 into a desired orientation via the application of their own force thereon. Any bending deformation is removed by the bending members 62, and the trailer skirt outer and inner surfaces 32, 34 assume their designed for shapes and positions so that the desired, designed for aerodynamic performance of the trailer skirt 14 is achieved. Although the bending member 62 and skirt attachment 64 function to pull the trailer skirt 14 back into its desired position, these components are not always required in various embodiments because it could be the case that tension is not imparted onto the trailer skirt 14 upon attachment, or because deformation does not occur or is not excessive enough to require correction via the bending member 62 and skirt attachment 64.

When the trailer skirt 14 is in tension via the arrangement of the first and second attachment locations 42, 44 and/or the attachment method as previously discussed, the tension in the trailer skirt 14 functions to pre-load the trailer skirt 14 and provide stiffness to the trailer skirt 14. If the trailer skirt 14 is pre-tensioned it will not flutter or will not flutter as much upon the tractor trailer 12 driving down the road. This will cause the trailer skirt 14 to vibrate less and less deformation of the trailer skirt 14 will result so that better aerodynamic gains will be realized. Application of tension to the trailer skirt 14 preloads the panels of the trailer skirt 14 which increases the initial stiffness of the trailer skirt 14 and prevents it from being deformed or from fluttering during normal driving operations.

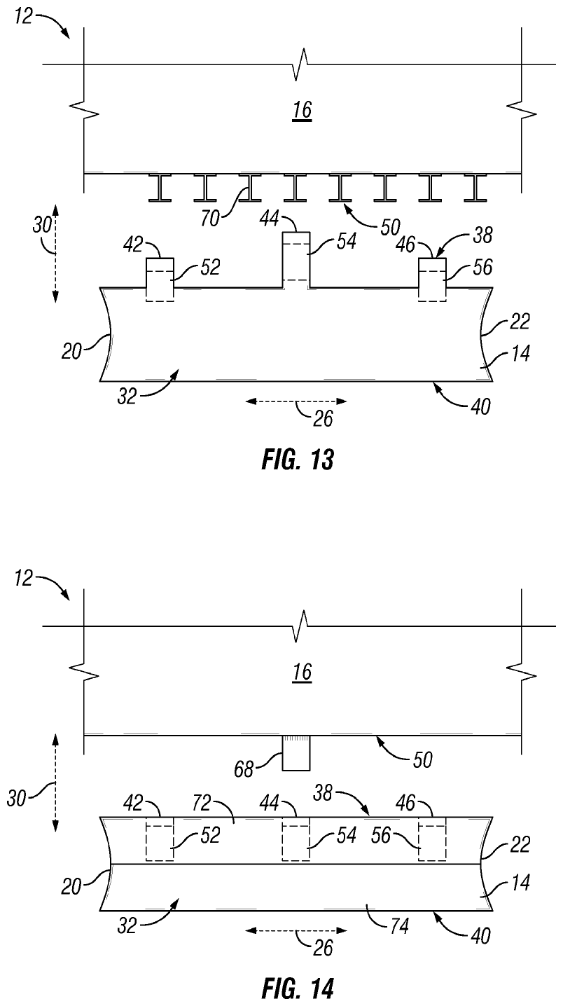

FIG. 13 shows another embodiment of the trailer skirt 12 in which the lower surface 40 and most of the upper surface 38 are both flat and parallel to the longitudinal direction 26. The upper surface 38 includes three tabs that extend from portions of the upper surface 38 and the three attachment locations 42, 44, 46 are located at these three tabs, in addition to three mounting brackets 52, 54, 56. The second attachment location 44 and second mounting bracket 54 are again located higher in the vertical direction 30 than are the first and third attachment locations 42, 46 and the first and third mounting brackets 52, 56. The upper surface 38 includes only straight, flat horizontal and vertical surfaces and does not include any convex or inclined surfaces. The bottom surface 50 in this case is made up of the bottom surfaces of a plurality of I-beams 70 of the trailer 16. The I-beams 70 are spaced from one another in the longitudinal direction 26 and as a result the bottom surface 50 is not a continuous bottom surface but is discontinuous at different locations in the longitudinal direction 26. The I-beams 70 for a bottom surface 50 that is not concave but instead is arranged in a parallel orientation to the longitudinal direction 26. The mounting brackets 52, 54, 56 can be attached to the I-beams 70 and the arrangement presented will cause the lower surface 40 and the bottom section of the trailer skirt 14 to be placed into tension. In the various embodiments discussed, since the trailer skirt 14 is attached to the bottom of the trailer 16 the top of the trailer skirt 14 is not a free edge, and the tension in the bottom of the trailer skirt 14 will not cause compression in the top of the trailer skirt 14 because this attachment will instead transfer the compression to the trailer 16 and due to its size and strength it will not cause the trailer 16 to deform.

It is to be understood that the apparatus 10 can be arranged to work with bottom surfaces 50 that are concave in shape, straight in shape, or irregular in shape. Further, the trailer skirt 14 could have a convex upper surface 38 or mounting brackets 52, 54, 56 that attach to the trailer 16 so that no compression or tension is imparted onto the trailer skirt 14. In other embodiments, the match may not be exact so that compression is still present, but the magnitude of compression is reduced or not as much compression is imparted. In other embodiments, the match may be great enough and combined with the attachment method so that tension is imparted onto the trailer skirt 14. The bottom surface 50 may be bottoms of I-beams 70 of the trailer 16 or can be bottoms of side walls of the trailer 16 or can be combinations of these surfaces, and or may be other portions of the trailer 16. The mounting brackets 52, 54, 56 and bending members 62 can be attached to the same or different ones of these surfaces of the trailer 16.

The trailer skirt 14 features an upper surface 38 that is shaped differently than the counterpart bottom surface 50 to which it is attached. This difference in shape is selected so that tension is applied to the trailer skirt 14 by having the ends of the trailer skirt 14 pulled farther in the vertical direction 30 than the middle of the trailer skirt 14. The other embodiments include an upper surface 38 that is shaped the same as the bottom surface 50, and this embodiment will still remove compression that would otherwise be imparted onto the trailer skirt 14 to improve its aerodynamic performance. As described herein, the attachment mounting brackets 52, 54, 56 could be, but do not necessarily have to be, positioned so that they are not all at the same position in the vertical direction 30.

The upper surface 38 can be shaped so that it changes height in the vertical direction 30 upon extension in the longitudinal direction 26 along at least 50% of the length 24 of the trailer skirt 14. In this regard, along at least 50% of the length 24 the upper surface 38 is either increasing or decreasing in height in the vertical direction 30 and is not maintaining the same position in the vertical direction 30 upon extension in the longitudinal direction 26. If the upper surface 38 were convex along its entire length in the longitudinal direction 26, then it would be shaped so that it changes height in the vertical direction 30 upon extension in the longitudinal direction 26 along 100% of the length 24. As such, embodiments exist in which some of the length of the upper surface 38 does maintain the same height in the vertical direction 30 along some of its length 24 in the longitudinal direction 26. However, the upper surface 38 should vary along some of the length 24 in the vertical direction 30 so that first and second portions 42, 44 can likewise vary in vertical position. In other embodiments, the upper surface 38 changes height in the vertical direction 30 upon extension in the longitudinal direction 26 along at least 80% of the length 24.

The method of attaching the trailer skirt 14 to the trailer 16 can be described in another embodiment with reference to FIG. 14 in which the bottom surface 50 is straight in the longitudinal direction 26. The trailer skirt 14 has an upper surface 38 that is likewise straight in the longitudinal direction 26 and does not have a height that varies in the vertical direction 30. As such, the method can be practiced in which both the upper surface 38 and the bottom surface 50 are straight in the longitudinal direction 26 without any up or down extension in the vertical direction 30. The trailer skirt 14 has an upper half 72 that is the top half of the trailer skirt 14 in the vertical direction 30 and has a lower half 74 that is the lower half of the trailer skirt 14 in the vertical direction 30. The line shown in FIG. 14 between the upper and lower halves 72, 74 demarcates the boundary line between them but may or may not be physically present in the trailer skirt 14. A spacer 68 is present on the trailer 16 and is attached to the bottom surface 50 and extends downward from the bottom surface 50 in the vertical direction 30. The trailer skirt 14 has three mounting brackets 52, 54, 56 that are located at the same vertical 30 position and are all sized and shaped the same. The three attachment locations 42, 44, 46 are at the top of the three mounting brackets 52, 54, 56 and likewise share the same vertical 30 positioning as one another. These attachment locations 42, 44, 46 are at the same vertical 30 position as the upper surface 38 but are not part of the upper surface 38. The trailer skirt 14 is free from contact with the trailer 16 in FIG. 14 and is positioned next to it for attachment. The mounting brackets 52, 54, 56 can be bolted onto the inner surface 34 or attached thereto via any attachment mechanism.

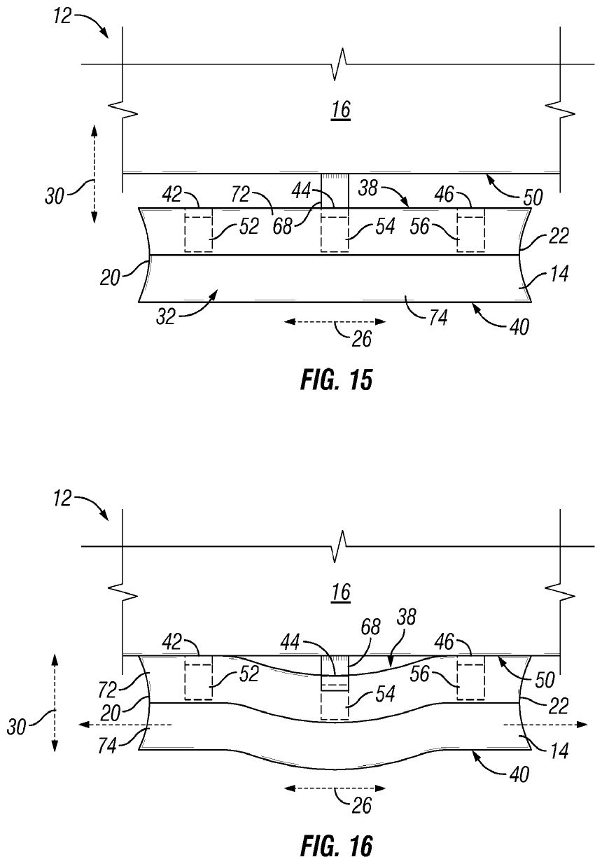

The trailer skirt 14 is positioned against the trailer 16 so that the spacer 68 engages the second attachment location 44 which is at the second mounting bracket 54. This point of the attachment process is shown in FIG. 15. Bolts or other attachment mechanisms are used to attach the second mounting bracket 54 to the spacer 68 so that the second attachment location 44 is attached to the spacer 68. At this point, the first and third attachment locations 42, 46 are not in engagement with the bottom surface 50 or any other portion of the trailer 16 and tension and compression is not imparted onto the trailer skirt 14.

Next, as shown in FIG. 16 the first and third attachment locations 42, 46 can be attached to the trailer 16 and these attachments can be done simultaneously or either one of the first or second attachment locations 42, 46 could be attached first before the other. The first attachment location 42 may be moved into engagement with the bottom surface 50 and the first mounting bracket 52 can be bolted or otherwise attached to the bottom surface 50 via any type of connection. When pulling the first attachment location 42 into engagement with the bottom surface 50 for attachment, the portion of the trailer skirt 14 that is at the same position as the first attachment location 42 in the longitudinal direction 26 is likewise pulled vertically upwards in the vertical direction 30 towards the bottom surface 50. This portion of the trailer skirt 14 longitudinally at the first attachment location 42 could be somewhat forward and/or rearward of the first attachment location 42 in the longitudinal direction 26 but will be generally in the area of the first attachment location 42.

The trailer skirt 14 can be pulled into engagement with the bottom surface 50 so that the third mounting bracket 56 engages the bottom surface 50 and is attached to it with bolts or other attachment mechanisms to cause the third attachment location 46 to be attached to the bottom surface 50. Pulling the trailer skirt 14 upwards at this point causes portions of the trailer skirt 14 at the same longitudinal position as the third attachment location 46 to likewise be pulled upwards in the vertical direction 30. Again, portions of the trailer skirt 14 forward and/or rearward of the third attachment location 46 may also be displaced upwards in the vertical direction 30 but these portions are generally in the area of the third attachment location 46 in the longitudinal direction 26.

The attachment process can be described as deforming upwards in the vertical direction 30 the portions of the trailer skirt 14 at the same positions in the longitudinal direction 26 as the first and third attachment locations 42, 46. The portions of the trailer skirt 14 at the same position in the longitudinal direction 26 as the second attachment location 44 are not deformed upwards in the vertical direction upon attachment. This area of the trailer skirt 14 may remain undeformed upon attachment and not deformed up or down in the vertical direction 30.

Another way of describing the attachment would be to say that the portions of the trailer skirt 14 at the same longitudinal positions as the first and third attachment locations 42, 46 are not deformed up or down in the vertical direction 30 upon attachment, and the portions of the trailer skirt 14 at the same longitudinal position as the second attachment location 44 are deformed downwards in the vertical direction 30. In this regard, in other embodiments, the first and third attachment locations 42, 46 can be attached first and then subsequently the second attachment location 44 can be attached to the spacer 68 or bottom surface 50. As such, the method can be described as deforming the first and third attachment locations 42, 46 without deformation of the second attachment location 44, and this same method can be described as deforming the second attachment location 44 down without deformation of the first and third attachment locations 42, 46.

The attachment process because of the deformation causes tension to be imparted onto the trailer skirt 14 that functions to reduce or eliminate deformation of the trailer skirt 14 and to prevent fluttering during driving of the vehicle. The tension 14 can be imparted onto the entire lower half 74, or some of the lower half 74, while tension is not present in any of the upper half 72. In other embodiments, tension may also be present in the upper half 72, and tension can be present in the entire trailer skirt 14. In these embodiments, the corresponding compression from the tension of the trailer skirt 14 will be in the trailer 16 and since the trailer 16 is a large structural component relative to the trailer skirt 14 the compression put onto it will not cause any deformation. In these instances, the top of the trailer skirt 14 may be in compression but since it is not a free edge the entire trailer 16 will be put into compression but likewise would not deform due to its size relative to the compressive force applied.

Upon attachment, the trailer skirt 14 may bend outwards or inwards in the lateral direction 28 due to the application of the tension. One or more bending members 62 and skirt attachments 64 can be incorporated into the method in order to pull the trailer skirt 14 back into a vertical position so that the deformation in the lateral direction 28 is removed. The method can thus include a concave shaped upper surface 38 and/or brackets 42, 44, 46 that are offset so that the front and back of the trailer skirt 14 are higher in the vertical direction 30 to apply the tension.

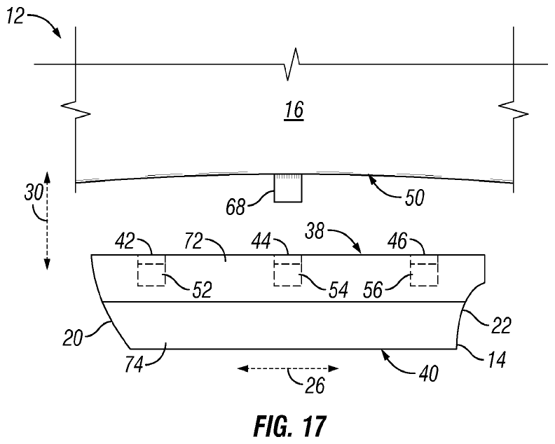

FIG. 17 shows an embodiment of the method in which the bottom surface 50 is concave in shape while the upper surface 38 is straight in shape. The spacer 68 is again present and extends from the bottom surface 50 downwards. As described herein, the spacer 68 can be identified as being part of the bottom surface 50 since one or more of the attachment locations 42, 44, 46 can be attached to it. As such, as used herein, the term bottom surface may refer to any portion of the trailer 16 or component on the trailer 16 to which the trailer skirt 14 is attached. In some embodiments, the trailer skirt 14 only engages a spacer 68 and no other portion of the trailer skirt 16 and such spacer 68 may extend along the entire length of the trailer skirt 14 in the longitudinal direction 26. Again three mounting brackets 52, 54, 56 are present and the three attachment locations 42, 44, 46 could be at the upper surface 38 or at these mounting brackets 52, 54, 56. It is to be understood that any number of additional mounting brackets and/or attachment locations could be present in other embodiments and they need not be limited to 2 or 3 as shown in some of the embodiments herein.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A method of attaching a trailer skirt to a trailer, comprising:
providing a trailer skirt that has a leading terminal end and a trailing terminal end and a length that extends in a longitudinal direction from the leading terminal end to the trailing terminal end, wherein the trailer skirt has an outer surface and an inner surface that are spaced from one another in a lateral direction and that define between them a width of the trailer skirt, wherein the trailer skirt has an upper surface and a lower surface that are spaced from one another in a vertical direction, wherein the trailer skirt has a first attachment location and a second attachment location in which the first attachment location is located forward of the second attachment location in the longitudinal direction so as to be closer to the leading terminal end in the longitudinal direction, and wherein the trailer skirt has a third attachment location that is located rearward of the second attachment location in the longitudinal direction so as to be closer to the trailing terminal end in the longitudinal direction;
providing a trailer of a tractor trailer; and
attaching the trailer skirt to the trailer at the first, second, and third attachment locations such that the lower surface is placed into tension;
wherein the trailer skirt at the same positions in the longitudinal direction as the first attachment location and the third attachment locations are deformed upwards in the vertical direction upon attachment of the trailer skirt to the trailer.

2. (canceled)

3. The method as set forth in claim 1, wherein the trailer skirt at the same position in the longitudinal direction as the second attachment location is not deformed upwards in the vertical direction upon attachment of the trailer skirt to the trailer.

4. The method as set forth in claim 1, wherein the upper surface extends from the leading terminal end to the trailing terminal end in the longitudinal direction, and wherein the entire upper surface from the trailing terminal end to the leading terminal end is convex in shape.

5. The method as set forth in claim 1, wherein the trailer skirt has a first mounting bracket, a second mounting bracket, and a third mounting bracket, wherein the first attachment location is located at the first mounting bracket, wherein the second attachment location is located at the second mounting bracket, and wherein the third attachment location is located at the third mounting bracket; and
wherein the first, second and third mounting brackets are attached to the trailer.

6. The method as set forth in claim 1, wherein a bottom surface of the trailer is flat in shape upon extension in the longitudinal direction, and wherein the first, second and third attachment locations are attached to the bottom surface of the trailer.

7. A method of attaching a trailer skirt to a trailer, comprising:
providing a trailer skirt that has a leading terminal end and a trailing terminal end and a length that extends in a longitudinal direction from the leading terminal end to the trailing terminal end, wherein the trailer skirt has an outer surface and an inner surface that are spaced from one another in a lateral direction and that define between them a width of the trailer skirt, wherein the trailer skirt has an upper surface and a lower surface that are spaced from one another in a vertical direction, wherein the trailer skirt has a first attachment location and a second attachment location in which the first attachment location is located forward of the second attachment location in the longitudinal direction so as to be closer to the leading terminal end in the longitudinal direction, and wherein the trailer skirt has a third attachment location that is located rearward of the second attachment location in the longitudinal direction so as to be closer to the trailing terminal end in the longitudinal direction;
providing a trailer of a tractor trailer; and
attaching the trailer skirt to the trailer at the first, second, and third attachment locations such that the lower surface is placed into tension;
wherein a bottom surface of the trailer is concave in shape upon extension in the longitudinal direction, and wherein the first, second and third attachment locations are attached to the bottom surface of the trailer;
wherein at least a portion of the upper surface of the trailer skirt is convex in shape, and wherein the bottom surface of the trailer has a radius of curvature that is different than a radius of curvature of the convex shaped upper surface.

8. (canceled)

9. A method of attaching a trailer skirt to a trailer, comprising:
providing a trailer skirt that has a leading terminal end and a trailing terminal end and a length that extends in a longitudinal direction from the leading terminal end to the trailing terminal end, wherein the trailer skirt has an outer surface and an inner surface that are spaced from one another in a lateral direction and that define between them a width of the trailer skirt, wherein the trailer skirt has an upper surface and a lower surface that are spaced from one another in a vertical direction, wherein the trailer skirt has a first attachment location and a second attachment location in which the first attachment location is located forward of the second attachment location in the longitudinal direction so as to be closer to the leading terminal end in the longitudinal direction, and wherein the trailer skirt has a third attachment location that is located rearward of the second attachment location in the longitudinal direction so as to be closer to the trailing terminal end in the longitudinal direction;
providing a trailer of a tractor trailer; and
attaching the trailer skirt to the trailer at the first, second, and third attachment locations such that the lower surface is placed into tension;
wherein the trailer skirt at the same position in the longitudinal direction as the second attachment location is deformed downwards in the vertical direction upon attachment of the trailer skirt to the trailer.

10. The method as set forth in claim 9, wherein a spacer engages the trailer and the second attachment location and functions to cause the downwards deformation in the vertical direction of the trailer skirt at the same position in the longitudinal direction as the second attachment location.

11. The method as set forth in claim 1, wherein the upper surface of the trailer skirt from the leading terminal end to the trailing terminal end in the longitudinal direction is flat such that the height of the upper surface does not change in the vertical direction.

12. The method as set forth in claim 1, further comprising:
a bending member configured for being attached to a bottom surface of the trailer;
a skirt attachment attached to the trailer skirt, wherein the bending member is in sliding engagement with the skirt attachment, and wherein deflection of the trailer skirt in the lateral direction by a deflection force is resisted by the bending member such that the bending member urges the trailer skirt in the lateral direction opposite to the deflection force.

13. The method as set forth in claim 1, wherein a bottom surface of the trailer comprising I-beams that are spaced from one another in the longitudinal direction such that the bottom surface of the trailer is discontinuous in the longitudinal direction.

14. The method as set forth in claim 1, wherein the trailer skirt has an upper half and a lower half in the vertical direction such that both the upper half and the lower half extend the same amount in the vertical direction, wherein the entire lower half is placed into tension in the longitudinal direction upon attaching the trailer skirt to the trailer at the first, second, and third attachment locations.

15. The method as set forth in claim 14, wherein the entire trailer skirt including the upper half and the lower half is placed into tension in the longitudinal direction upon attaching the trailer skirt to the trailer at the first, second, and third attachment locations.
